(19) United States
(12) Patent Application Publication
(10) Pub. No.: US 2010/0194364 A1
(43) Pub. Date: Aug. 5, 2010

(54) Switching Power-Supply Control Circuit

(75) Inventors: Iwao Fukushi, Ora-gun (JP); Shuhei Kawai, Ora-gun (JP)

Correspondence Address: SoCAL IP LAW GROUP LLP, 310 N. WESTLAKE BLVD. STE 120, WESTLAKE VILLAGE, CA, 91362, US

(73) Assignees: Sanyo Electric Co., Ltd., Osaka (JP); Sanyo Semiconductor Co., Ltd., Ora-gun (JP)

(21) Appl. No.: 12/694,183

(22) Filed: Jan. 26, 2010

(30) Foreign Application Priority Data
Jan. 27, 2009 (JP) 2009-015923

(51) Int. Cl. G05F 1/10

(52) U.S. Cl. 323/282

(57) ABSTRACT

A switching-power-supply control circuit comprising: a first control circuit to operate a first transistor applied with an input voltage at an input electrode thereof and a second transistor connected in series to the first transistor, based on a first feedback voltage and first reference voltage, the first feedback voltage corresponding to an output voltage obtained through a connection point between the first and second transistors; and a second control circuit to allow the first control circuit to turn on/off the first and second transistors in a complementary manner so that the first feedback voltage becomes equal to the first reference voltage, when a second feedback voltage rising with rise of the output voltage is lower than a second reference voltage, and allow the first control circuit to turn off the second transistor, when the second feedback voltage is higher than the second reference voltage, according to the output voltage.

### CROSS-REFERENCE TO RELATED APPLICATION

This application claims the benefit of priority to Japanese Patent Application No. 2009-015923, filed Jan. 27, 2009, of which full contents are incorporated herein by reference.

### BACKGROUND OF THE INVENTION

1. Field of the Invention

The present invention relates to a switching power-supply control circuit.

2. Description of the Related Art

In general, a switching power-supply circuit generates from an input voltage a desired output voltage to be supplied to a load (See Japanese Patent Laid-Open Publication No. 2003-264978, for example). FIG. 4 illustrates an example of a switching power-supply circuit 100.

A control circuit 200 turns on/off NMOS transistors 301, 302 in a complementary manner on the basis of a feedback voltage Vfb obtained by dividing an output voltage Vout and a voltage Vref1 of a reference voltage circuit 300, when a signal of an L-level is input from a latch circuit 304. Specifically, the control circuit 200 performs switching of the NMOS transistors 301, 302 so that the output voltage Vout charged in a capacitor C rises, when the feedback voltage Vfb becomes lower than the reference voltage Vref1. On the other hand, the control circuit 200 performs switching of the NMOS transistors 301, 302 so that the output voltage Vout drops, when the feedback voltage Vfb becomes higher than the reference voltage Vref1. As such, the output voltage Vout is controlled by the control circuit 200 so as to become the desired level. Moreover, the control circuit 200 keeps the NMOS transistor 302 on so as to lower the output voltage Vout to the desired level, when the output voltage Vout rises and an overvoltage occurs. As a result, an excessive reverse current caused by the overvoltage continues to flow through the NMOS transistor 302 which is turned on, and thus, there is a risk that the NMOS transistor 302 is burned out.

An overvoltage detection circuit 201 monitors the output voltage Vout by comparing the output voltage Vout and a voltage Vref2 of a reference voltage circuit 303, and if the overvoltage occurs, the circuit prevents burnout of the NMOS transistor 302 with the latch circuit 304. Specifically, the overvoltage detection circuit 201 outputs a shut-down signal of an H-level, if the output voltage Vout becomes higher than the voltage Vref2 of the reference voltage circuit 303 and the overvoltage occurs. If the shut-down signal of the H-level is input from the overvoltage detection circuit 201, the latch circuit 304 outputs a signal of the H-level to the control circuit 200 to turn off the NMOS transistors 301, 302. Therefore, the excessive reverse current caused by the overvoltage does not flow through the NMOS transistor 302, and consequently, the NMOS transistor 302 can be prevented from being burned out.

Furthermore, if it is detected that the output voltage Vout have become equal to the voltage Vref2 of the reference voltage circuit 303 or less, that is, that the output voltage Vout is not excessive to an overvoltage extent, a microcomputer 305 outputs a shut-down release signal to the latch circuit 304. If the shut-down release signal is input to the latch circuit 304, the control circuit 200 resumes controlling the NMOS transistors 301, 302 on the basis of the feedback voltage Vfb and the reference voltage Vref1.

The overvoltage detection circuit 201 outputs the shut-down signal of the H-level to the latch circuit 304 to allow the control circuit 200 to turn off the NMOS transistors 301, 302, thereby preventing burnout of the NMOS transistor 302. However, since the latch circuit 304 holds the shut-down signal, the control circuit 200 cannot autonomously resume controlling the transistors 301, 302. Therefore, it is required to release such shut-down by the external microcomputer 305 so as to resume controlling the transistors 301, 302 by the control circuit 200.

### SUMMARY OF THE INVENTION

A switching power-supply control circuit according to an aspect of the present invention, comprises: a first control circuit configured to operate a first transistor and a second transistor based on a first feedback voltage and a first reference voltage, the first transistor configured to be applied with an input voltage at an input electrode thereof, the second transistor connected in series to the first transistor, the first feedback voltage corresponding to an output voltage obtained through a connection point between the first transistor and the second transistor; and a second control circuit configured to allow the first control circuit to turn on/off the first transistor and the second transistor in a complementary manner so that the first feedback voltage becomes equal to the first reference voltage, when a second feedback voltage rising with rise of the output voltage is lower than a second reference voltage, and allow the first control circuit to turn off the second transistor, when the second feedback voltage is higher than the second reference voltage, according to the output voltage.

Other features of the present invention will become apparent from descriptions of this specification and of the accompanying drawings.

### BRIEF DESCRIPTION OF THE DRAWINGS

For more thorough understanding of the present invention and advantages thereof, the following description should be read in conjunction with the accompanying drawings, in which:

FIG. 1 is a diagram illustrating a switching power-supply circuit 10 according to an embodiment of the present invention;

FIG. 2 is a diagram for describing an operation of a switching power-supply circuit 10 when an output voltage Vout is not excessive to an overvoltage extent;

FIG. 3 is a diagram for describing an operation of a switching power-supply circuit 10 when an output voltage Vout is excessive to an overvoltage extent; and

FIG. 4 is a diagram illustrating an example of a switching power-supply circuit.

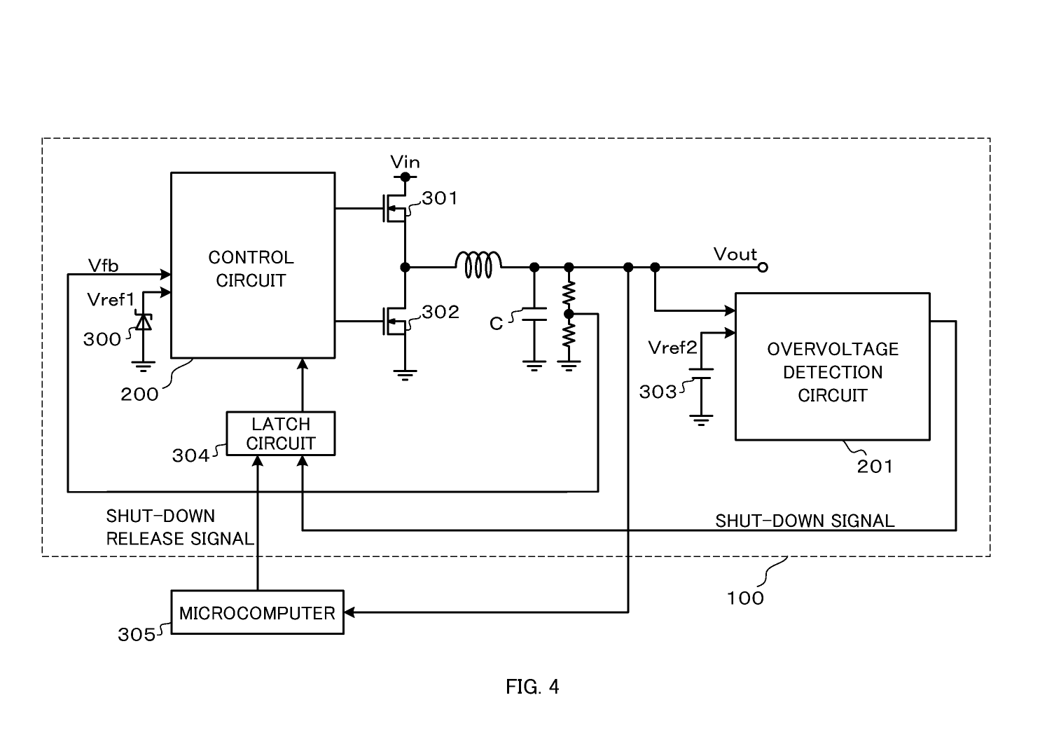

### DETAILED DESCRIPTION OF THE INVENTION

At least the following details will become apparent from descriptions of this specification and of the accompanying drawings.

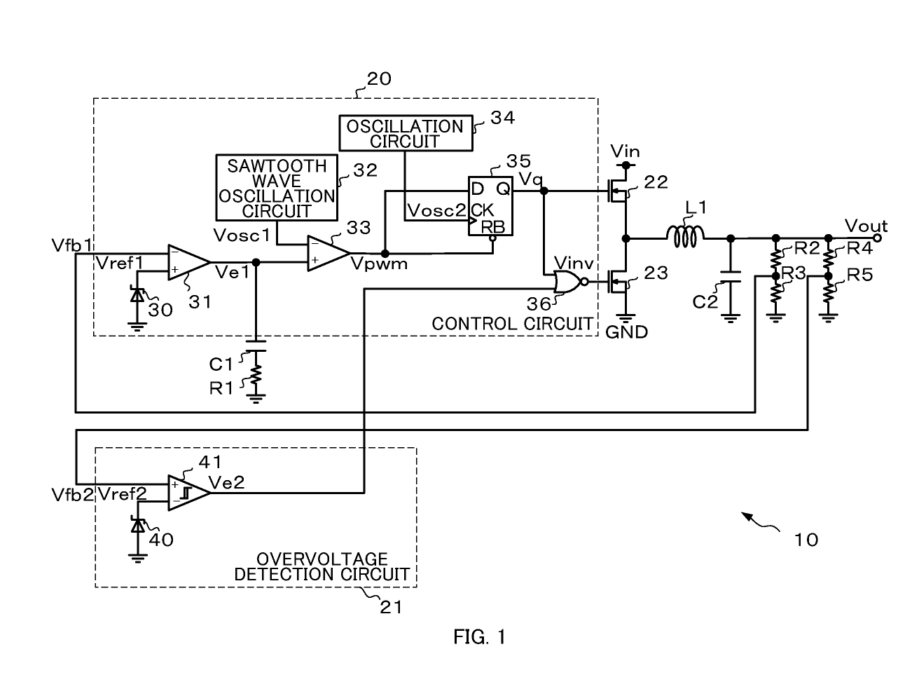

FIG. 1 is a diagram illustrating a configuration of a switching power-supply circuit 10 according to an embodiment of the present invention. The switching power-supply circuit 10 is used for generating a desired output voltage Vout to be supplied to a load (not shown) from an input voltage Vin, which is a voltage of a battery, for example.

The switching power-supply circuit 10 includes a control circuit 20, an overvoltage detection circuit 21, NMOS transistors 22, 23, an inductor L1, capacitors C1, C2, and resistors R1 to R5. Though a terminal is not shown in FIG. 1, it is assumed that the control circuit 20, the overvoltage detection circuit 21, and the NMOS transistors 22, 23 in an embodiment of the present invention are integrated. Also, the control circuit 20 and the overvoltage detection circuit 21 correspond to the switching power-supply control circuit.

The control circuit 20 (first control circuit) is a circuit that performs switching of the NMOS transistors 22 and 23 to generate the desired output voltage Vout from the input voltage Vin. The control circuit 20 includes a reference voltage circuit 30, an error amplification circuit 31, a sawtooth-wave oscillation circuit 32, a comparator 33, an oscillation circuit 34, a D flip-flop 35, and an NOR gate 36.

The reference voltage circuit 30 is a circuit that generates a reference voltage Vref1 (first reference voltage) of a predetermined level such as a bandgap voltage, for example.

The error amplification circuit 31 is a circuit that amplifies a difference between the reference voltage Vref1 and a voltage Vfb1 (first feedback voltage) obtained by dividing the output voltage Vout by the resistors R2, R3. In the error amplification circuit 31 according to an embodiment of the present invention, the capacitor C1 and the resistor R1 for phase compensation of a feedback loop of the switching power-supply circuit 10 are connected between an output of the error amplification circuit 31 and a GND. In an embodiment of the present invention, it is assumed that a voltage of a node to which the output of the error amplification circuit 31 and the capacitor C1 are connected is a voltage Ve1 (charging voltage).

The sawtooth-wave oscillation circuit 32 is a circuit that outputs a sawtooth wave Vosc1 having a predetermined period.

The comparator 33 is a circuit that compares the output voltage Ve1 from the error amplification circuit 31 and the sawtooth wave Vosc1 to output a PWM signal Vpwm. In an embodiment of the present invention, the voltage Ve1 is input to a non-inverting input terminal of the comparator 33, and the sawtooth wave Vosc1 is input to an inverting input terminal of the comparator 33. When the sawtooth wave becomes lower in level than the voltage Ve1, the PWM signal Vpwm becomes an H level, and when the sawtooth wave becomes higher in level than the voltage Ve1, the PWM signal Vpwm becomes an L level. Hereinafter, in an embodiment of the present invention, it is assumed that a time period during which the PWM signal Vpwm is at the L level in one cycle of the PWM signal Vpwm is a duty ratio of the PWM signal Vpwm.

The oscillation circuit 34 is a circuit that outputs a pulse signal Vosc2 whose time period of the H level in one cycle is short, in such timing that the sawtooth wave Vosc1 changes from falling to rising. The oscillation circuit 34 according to an embodiment of the present invention has the same oscillator (not shown) as the sawtooth-wave oscillation circuit 32 does to be used as an oscillation source, so that a pulse signal Vosc2 can be output with the same cycle as that of the sawtooth-wave oscillation circuit 32 and in the above-mentioned timing.

The D flip-flop 35 is a circuit that synchronizes the output PWM signal Vpwm from the comparator 33 with the pulse signal Vosc2 to output a signal Vq to the NMOS transistor 22 (first transistor) and the NOR gate 36. If the PWM signal Vpwm is at the H level, the signal Vq becomes the H level concurrently with rising of the Vosc2, and if the PWM signal Vpwm is at the L level, the D flip-flop 35 is reset and the signal Vq becomes the L level.

The NOR gate 36 is a circuit that outputs a signal Vinv obtained by inverting the output signal Vq from the D flip-flop 35 to the NMOS transistor 23 (second transistor) if an output signal Ve2 of a comparator 41 is at the L level and that outputs the L-level signal Vinv to the NMOS transistor 23 if the output signal Ve2 becomes the H level. Therefore, the control circuit 20 can turn on/off the NMOS transistors 22, 23 in a complementary manner by the output signals Vq, Vinv if the output signal Ve2 of the comparator 41 is at the L level.

The sawtooth-wave oscillation circuit 32, the comparator 33, the oscillation circuit 34, the D flip-flop 35, and the NOR gate 36 correspond to a driving circuit.

The overvoltage detection circuit 21 (second control circuit) is a circuit that monitors the output voltage Vout by comparing a voltage Vfb2 (second feedback voltage) obtained by dividing the output voltage Vout by the resistors R4, R5 and the voltage Vref2 of a reference voltage circuit 40, and prevents burnout by turning off the NMOS transistor 23 when an overvoltage occurs. The overvoltage detection circuit 21 includes the reference voltage circuit 40 and the comparator 41.

The reference voltage circuit 40 is a circuit that generates the reference voltage Vref2 at a predetermined level.

The comparator 41 (control signal output circuit) generates an upper threshold voltage Vth (second reference voltage), which is 1.2 times the reference voltage Vref2, and a lower threshold voltage Vt1 (third reference voltage), which is 1.1 times the reference voltage Vref2, for example, in the comparator 41 on the basis of the reference voltage Vref2. The comparator 41 is a circuit that compares the voltage Vfb2 and the upper threshold voltage Vth if the voltage Vfb2 is rising, and compares the voltage Vfb2 and the lower threshold voltage Vt1 if the voltage Vfb2 is dropping, to output the signal Ve2 (control signal). In an embodiment of the present invention, it is assumed that the upper threshold voltage Vth is a voltage indicating that the output voltage Vout is excessive to an overvoltage extent, and the lower threshold voltage Vt1 is a voltage indicating that the output voltage Vout is not excessive to an overvoltage extent. The comparator 41 allows the signal Ve2 to reach the H level if the voltage Vfb2 becomes higher in level than the upper threshold voltage Vth. On the other hand, the comparator 41 allows the signal Ve2 to reach the L level if the voltage Vfb2 becomes lower in level than the lower threshold voltage Vt1.

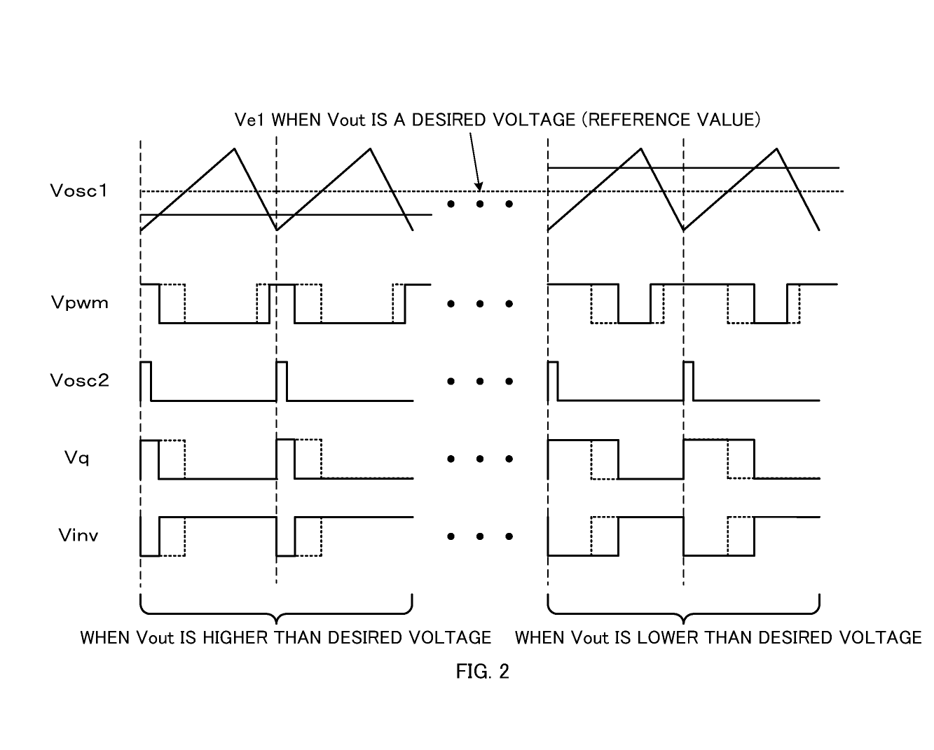

Here, there will be described referring to FIG. 2 an operation of the switching power-supply circuit 10 if the output voltage Vout is not excessive to the overvoltage extent and the desired output voltage Vout is generated. If the output voltage Vout is not excessive to the overvoltage extent, the comparator 41 outputs the signal Ve2 at the L level since the voltage Vfb2 becomes lower in level than the lower threshold voltage Vt1. Therefore, the control circuit 20 turns on/off the NMOS transistors 22, 23 in the complementary manner by the output signals Vq, Vinv.

Each waveform in a broken line in FIG. 2 is a reference waveform when the output voltage Vout is the desired voltage, and each waveform in a solid line indicates a waveform when the output voltage Vout is higher or lower than the desired voltage. If the output voltage Vout rises to be higher than the desired voltage and the voltage Vfb1 to be applied to the error amplification circuit 31 becomes higher than the reference voltage Vref1, the error amplification circuit 31 discharges an electric charge in the capacitor C1 to the ground GND, and thus, the voltage Ve1 drops from the reference value. If the voltage Ve1 is lowered from the reference value, the comparator 33 outputs the PWM signal Vpwm greater in duty ratio than the PWM signal Vpwm indicated by the broken line. As mentioned above, the oscillation circuit 34 outputs the pulse signal Vosc2, which rises at the same time as the rising of the sawtooth wave Vosc1. The D flip-flop 35 synchronizes the PWM signal Vpwm with the pulse signal Vosc2 to output the signal Vq to the NMOS transistor 22. The signal Vq output on the basis of the PWM signal Vpwm greater in duty ratio than the PWM signal Vpwm indicated by the broken line has a time period of the L level longer than the signal Vq indicated by the broken line, and thus, a time period during which the NMOS transistor 22 is off becomes longer. On the other hand, the NOR gate 36 outputs the signal Vinv having a time period of the H level longer than the signal Vinv indicated by the broken line, and thus, a time period during which the NMOS transistor 23 is on becomes longer. Therefore, a discharge time becomes relatively longer than a charge time in the capacitor C2, and consequently, the capacitor C2 is discharged through the NMOS transistor 23. As a result, the output voltage Vout having been higher than the desired voltage drops.

On the other hand, if the output voltage Vout drops to be lower than the desired voltage and the voltage Vfb1 becomes lower than the reference voltage Vref1, the error amplification circuit 31 charges the electric charge in the capacitor C1, and the voltage Ve1 rises from the reference value. If the voltage Ve1 rises from the reference value, the comparator 33 outputs the PWM signal Vpwm smaller in duty ratio than the PWM signal Vpwm indicated by the broken line. The signal Vq output on the basis of the PWM signal Vpwm smaller in duty ratio than the PWM signal Vpwm indicated by the broken line has a time period of the H level longer than the signal Vq indicated by the broken line, and thus, the time period during which the NMOS transistor 22 is on becomes longer. On the other hand, the NOR gate 36 outputs the signal Vinv having the time period of the L level longer than the signal Vinv indicated by the broken line, and thus, the time period during which the NMOS transistor 23 is off becomes longer. Therefore, the charge time becomes relatively longer than the discharge time in the capacitor C2, and consequently, the capacitor C2 is charged through the NMOS transistor 22. As a result, the output voltage Vout having been lower than the desired voltage rises.

As mentioned above, in an embodiment of the present invention, if the output voltage Vout is not excessive to the overvoltage extent, the output voltage Vout is controlled so as to become the desired level on the basis of the reference voltage Vref1.

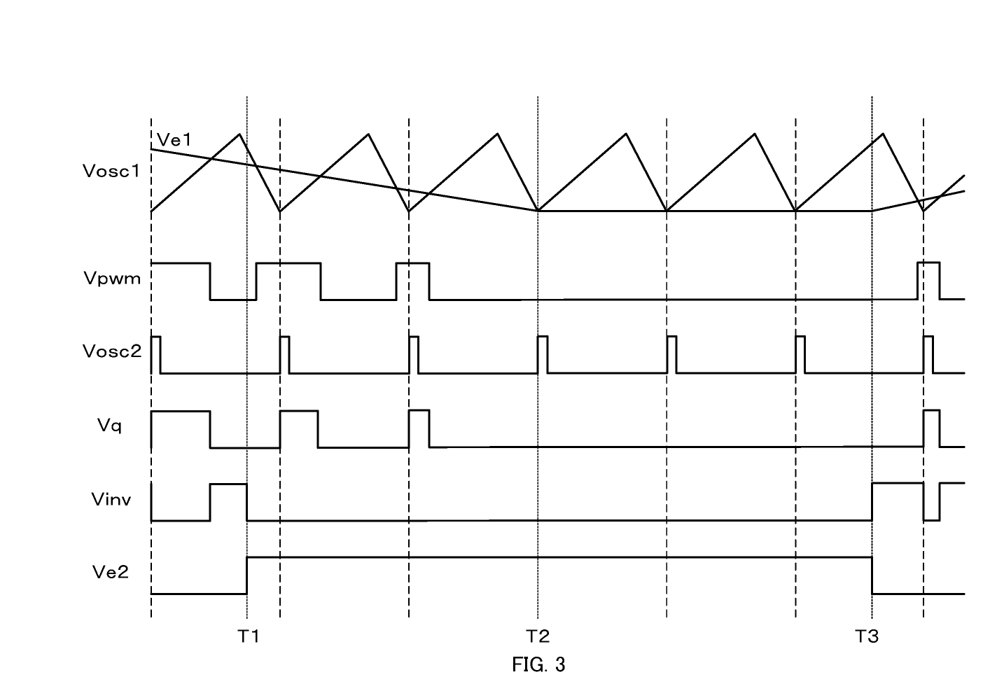

Subsequently, there will be described referring to FIG. 3 an operation of the switching power-supply circuit 10 if the output voltage Vout is excessive to the overvoltage extent. In FIG. 3, it is assumed that a time period between T1 to T3 is a time period during which the output voltage Vout is excessive to the overvoltage extent.

As shown in FIG. 3, if the output voltage Vout is excessive to the overvoltage extent at a time T1, for example, the voltage Vfb2 becomes higher in level than the upper threshold voltage Vth, and thus, the comparator 41 outputs the signal Ve2 at the H level. Therefore, the NOR gate 36 outputs the signal Vinv at the L-level to turn off the NMOS transistor 23. Moreover, if the output voltage Vout is excessive to the overvoltage extent, the voltage Vfb1 becomes higher than the reference voltage Vref1, and thus, the capacitor C1 is discharged so that the voltage Ve1 drops. Therefore, the control circuit 20 performs switching of the NMOS transistor 22 at the duty ratio corresponding to the level of the voltage Ve1. Subsequently, if the voltage Ve1 becomes lower in level than the sawtooth wave Vosc1 at a time T2, for example, the comparator 33 sets the duty ratio of the PWM signal Vpwm at 100%. Therefore, the comparator 33 continues to reset the D flip-flop 35, and the D flip-flop 35 continues to turn off the NMOS transistor 22. As mentioned above, in an embodiment of the present invention, if the output voltage Vout is excessive to the overvoltage extent, the control circuit 20 turns off the NMOS transistors 22, 23.

If the output voltage Vout reaches a voltage, which is not is excessive to the overvoltage extent, at a time T3, for example, the voltage Vfb2 becomes lower in level than the lower threshold voltage Vt1, and thus, the comparator 41 outputs the signal Ve2 of the L-level. As a result, switching of the NMOS transistors 22, 23 by the control circuit 20 is resumed so that the output voltage Vout becomes the desired level as mentioned above.

In the switching power-supply circuit 10 according to an embodiment of the present invention having the configuration as mentioned above, if the output voltage Vout is not excessive to the overvoltage extent, the voltage detection circuit 21 allows the control circuit 20 to perform switching of the NMOS transistors 22, 23 in the complementary manner so that the reference voltage Vref1 becomes equal to the voltage Vfb1. On the other hand, if the output voltage Vout is excessive to the overvoltage extent, the overvoltage detection circuit 21 allows the control circuit 20 to turn off the NMOS transistor 23. Also, the control circuit 20 turns off the NMOS transistor 22 on the basis of the difference between the reference voltage Vref1 and the voltage Vfb1. Therefore, since an excessive reverse current caused by the overvoltage no longer flows through the NMOS transistor 23, burnout can be prevented. Thereafter, if the output voltage Vout is no longer excessive to the overvoltage extent, the overvoltage detection circuit 21 allows the control circuit 20 to resume the switching of the NMOS transistors 22, 23, as mentioned above. Therefore, in an embodiment of the present invention, after the output becomes excessive to the overvoltage extent, the control circuit 20 can resume controlling the NMOS transistors 22, 23 autonomously without an input of a signal from the outside.

In an embodiment of the present invention, the control circuit 20 allows the error amplification circuit 31 to charge/discharge the capacitor C1 on the basis of the difference between the reference voltage Vref1 and the voltage Vfb1. If the output voltage Vout is not excessive to the overvoltage extent, the comparator 41 outputs the signal Ve2 of the L-level. If the output signal Ve2 is at the L level, the D flip-flop 35 outputs the signal Vq according to the charging voltage Ve1 of the capacitor C1 and allows the NOR gate 36 to output the signal Vinv. In response to the signals Vq, Vinv, the control circuit 20 performs the switching of the NMOS transistors 22, 23 in the complementary manner so that the voltage Vfb1 becomes equal to the reference voltage Vref1. On the other hand, if the output voltage Vout becomes excessive to the overvoltage extent, the comparator 41 outputs the signal Ve2 of the H-level. If the signal Ve2 of the H-level is input, the NOR gate 36 outputs the signal Vinv of the L-level to turn off the NMOS transistor 23. Also, the control circuit 20 turns off the NMOS transistor 22 according to the charging voltage of the capacitor C1. Therefore, if the output voltage Vout becomes excessive to the overvoltage extent, the switching power-supply circuit 10 reliably protects the NMOS transistor 23, and if the output voltage Vout is no longer excessive to the overvoltage extent, the switching power-supply circuit 10 can resume controlling the NMOS transistors 22, 23.

Also, in an embodiment of the present invention, the overvoltage detection circuit 21 generates the upper threshold voltage Vth, which is 1.2 times the reference voltage Vref2, and the lower threshold voltage Vt1, which is 1.1 times the reference voltage Vref2, for example, in the comparator 41 on the basis of the reference voltage Vref2. In the case where the voltage Vfb2 rises, if the voltage Vfb2 becomes higher in level than the upper threshold voltage Vth, the comparator 41 sets the signal Ve2 at the H level. On the other hand, in the case where the voltage Vfb2 drops, if the voltage Vfb2 becomes lower in level than the lower threshold voltage Vt1, the comparator 41 sets the signal Ve2 at the L level. Therefore, in the case of the overvoltage, even if the voltage Vfb2 is fluctuated in level due to noise or the like, the control circuit 20 continues to turn off the NMOS transistor 23 when the level of the voltage Vfb2 is within a range between the upper threshold voltage Vth and the lower threshold voltage Vt1. Therefore, the NMOS transistor 23 can be reliably protected.

The above embodiments of the present invention are simply for facilitating the understanding of the present invention and are not in anyway to be construed as limiting the present invention. The present invention may variously be changed or altered without departing from its spirit and encompass equivalents thereof.

In an embodiment of the present invention, in order to allow the overvoltage detection circuit 21 to monitor the output voltage Vout, the upper threshold voltage Vth, which is 1.2 times the reference voltage Vref2, and the lower threshold voltage Vt1, which is 1.1 times the reference voltage Vref, are used, for example, however, even if detecting whether or not the overvoltage occurs using only the reference voltage Vref2, it is possible to obtain the same effect as that in the case of an embodiment of the present invention. In such case, the reference voltage Vref2 corresponds to the second reference voltage.

In an embodiment of the present invention, the sawtooth-wave oscillation circuit 32, the oscillation circuit 34, and the D flip-flop 35 are used, however, it is possible to obtain the same effect as that in the case of an embodiment of the present invention by a configuration in which a PWM signal is generated using a circuit generating a triangular wave having the same rising time and falling time instead of the sawtooth-wave oscillation circuit 32, for example.

In an embodiment of the present invention, the NMOS transistors 22, 23 are integrated, however, a configuration may be made using a discrete transistor.

In an embodiment of the present invention, the NMOS transistor 22 is used, however, a PMOS transistor may be used. In such case, an inverter for inverting the signal Vq is provided so as to allow the inverter to drive the PMOS transistor, and thus, it is possible to obtain the same effect as in the case of an embodiment of the present invention.

Moreover, the control circuit 20 according to an embodiment of the present invention has a configuration in which the NMOS transistor 22 is turned off in a gradual manner according to a change in the charging voltage of the capacitor C1 if the output voltage Vout becomes excessive to the overvoltage extent, however, the circuit may have a configuration in which the NMOS transistors 22, 23 are turned off at the same time, for example. For example, a configuration is made such that the control circuit 20 is provided with an NOR circuit to which a signal obtained by inverting the signal Vq of the D flip-flop 35 and the signal Ve2 of the comparator 41 are input and an output of the NOR circuit is output to the NMOS transistor 22, so that the NMOS transistor 22 can be turned off concurrently with the NMOS transistor 23. In such case, if the output voltage Vout reaches the overvoltage level, that is, if the signal Ve becomes the H level, the NMOS transistor 22 is turned off, and if the output voltage Vout becomes lower than a voltage excessive to the overvoltage extent, the switching of the NMOS transistor 22 is performed on the basis of the signal Vq. Therefore, it is possible to obtain the same effect as that in the case of an embodiment of the present invention.

What is claimed is:

1. A switching power-supply control circuit comprising:
a first control circuit configured to operate a first transistor and a second transistor based on a first feedback voltage and a first reference voltage, the first transistor configured to be applied with an input voltage at an input electrode thereof, the second transistor connected in series to the first transistor, the first feedback voltage corresponding to an output voltage obtained through a connection point between the first transistor and the second transistor; and
a second control circuit configured to
allow the first control circuit to turn on/off the first transistor and the second transistor in a complementary manner so that the first feedback voltage becomes equal to the first reference voltage, when a second feedback voltage rising with rise of the output voltage is lower than a second reference voltage, and
allow the first control circuit to turn off the second transistor, when the second feedback voltage is higher than the second reference voltage,
according to the output voltage.

2. The switching power-supply control circuit according to claim 1, wherein
the second control circuit includes a control signal output circuit configured to output a control signal of one logic level to the first control circuit when the second feedback voltage is lower than the second reference voltage, and output the control signal of the other logic level to the first control circuit when the second feedback voltage is higher than the second reference voltage, and wherein
the first control circuit includes:
an error amplification circuit configured to charge/discharge a capacitor with a voltage corresponding to a difference between the first feedback voltage and the first reference voltage; and
a driving circuit configured to
turn on/off the first transistor and the second transistor in a complementary manner so that the first feedback voltage becomes equal to the first reference voltage according to a charging voltage of the capacitor, when the control signal of the one logic level is input to the driving circuit, and
turn off the first transistor according to the charging voltage of the capacitor and turn off the second transistor based on the control signal of the other logic level, when the control signal of the other logic level is input to the driving circuit.

3. The switching power-supply control circuit according to claim 2, wherein
the control signal output circuit outputs the control signal of the other logic level to the first control circuit when the second feedback voltage becomes higher than the second reference voltage, and outputs the control signal of the one logic level to the first control circuit when the second feedback voltage becomes lower than a third reference voltage that is lower than the second reference voltage.
